(19) United States
(12) Patent Application Publication
(10) Pub. No.: US 2020/0194137 A1
(43) Pub. Date: Jun. 18, 2020

(54) Fuel Placement Confirmation Method and Fuel Placement Confirmation Apparatus

(71) Applicant: Hitachi-GE Nuclear Energy, Ltd., Hitachi-shi, Ibaraki (JP)

(72) Inventors: Takaaki KONISHI, Tokyo (JP); Ryousuke KOBAYASHI, Tokyo (JP); Shinji NAGANO, Hitachi-shi (JP); Chunchan LEE, Hitachi-shi (JP); Jin TANIGUCHI, Hitachi-shi (JP); Masayoshi SONOBE, Hitachi-shi (JP)

(21) Appl. No.: 16/469,414

(22) PCT Filed: Nov. 8, 2017
(86) PCT No.: PCT/JP2017/040196

§ 371 Date: Jun. 13, 2019

(30) Foreign Application Priority Data
Dec. 16, 2016 (JP) 2016-244266

(51) Int. Cl. G21C 17/06; G21C 17/08; G21C 17/02

(52) U.S. Cl. CPC G21C 17/06; G21C 17/02; G21C 17/08

(57) ABSTRACT

Provided are a fuel placement confirmation method and a fuel placement confirmation apparatus that can increase an underwater imaging distance, collectively image a wide region, and reliably confirm an imprint number of a fuel assembly in consideration of a water fluctuation. A fuel placement confirmation apparatus 1 includes an imaging device 2 which images a fuel assembly number imprinted on a fuel assembly 27 loaded into a core 12; a movement device 5 which holds the imaging device 2 and performs scanning in a horizontal plane above the fuel assembly 27; and a fuel placement confirmation processing unit 3 which causes the movement device 5 to perform scanning, repeatedly executes imaging by the imaging device 2 on at least the fuel assembly 27 to be a placement confirmation target, selects image data not including image distortion from a plurality of acquired imaged images, combines the image data, generates entire image data 44 of at least the fuel assembly to be the placement confirmation target, and outputs the entire image data 44 to a display unit 8.

### TECHNICAL FIELD

The present invention relates to a fuel placement confirmation method and a fuel placement confirmation apparatus for refueling work of a boiling water reactor.

### BACKGROUND ART

A fuel assembly loaded into a boiling water reactor of a nuclear power plant is stored in a storage pool as a spent fuel assembly after use. Movement of the spent fuel assembly from a core to the storage pool and loading of a new fuel assembly into the core are carried out as one step in a regular inspection. At this time, in order to confirm whether the fuel assembly has been extracted from a predetermined position or the fuel assembly has been loaded at the predetermined position, an imprint number imprinted on a handle provided on the fuel assembly is imaged by an underwater camera or the like, and it is determined from an imaged image whether or not the number is correct by visual observation of a person. In the conventional placement confirmation, since a large number of arranged fuel assemblies are confirmed for each row using one underwater camera, it takes a very long time to confirm imprint numbers of all the fuel assemblies. Therefore, as technology for shortening a time, for example, technology described in PTL 1 is proposed. PTL 1 discloses a fuel assembly loading confirmation apparatus in which an imaging device, a light projector, and a light projector angle adjustment device are installed in a movement device and the movement device is moved to a fuel imaging position in a reactor by a control device. Further, the imaging height of the imaging device is controlled to the height at which it is possible to image the number of recognizable fuel assemblies, according to the resolution of the imaging device, and at the same time, the movement coordinates at the time of imaging are controlled so that imaged fuels do not overlap. In addition, character enhancement processing of an imprint number portion of the fuel assembly and enhancement processing of an outline portion of the entire fuel assembly are performed on an imaged image, and character recognition processing is performed on the imprint number of the fuel assembly.

### CITATION LIST

### Patent Literature

PTL 1: JP 9-304576 A

### SUMMARY OF INVENTION

### Technical Problem

In order to confirm the imprint number of the fuel assembly more efficiently, it is desirable to be able to collectively image more fuel assemblies. However, in the technology described in PTL 1, when the imprint number of the fuel assembly cannot be recognized as characters, visual confirmation and input operation of the imprint number of the fuel assembly by a user are required, and a so-called water fluctuation in which distortion occurs in an imaged image because light does not go straight due to random refraction of light caused by a density difference in water is not considered at all.

Accordingly, the present invention provides a fuel placement confirmation method and a fuel placement confirmation apparatus that can increase an underwater imaging distance, collectively image a wide region, and reliably confirm an imprint number of a fuel assembly in consideration of a water fluctuation.

### Solution to Problem

In order to solve the above problems, a fuel placement confirmation method according to the present invention is a fuel placement confirmation method for refueling work of a boiling water reactor. The fuel placement confirmation method includes imaging a fuel assembly number imprinted on a fuel assembly by an imaging device attached to a movement device; causing the movement device to perform scanning and repeatedly executing imaging by the imaging device on at least the fuel assembly to be a placement confirmation target; and selecting image data not including image distortion from a plurality of acquired imaged images, combining the image data, generating entire image data of at least the fuel assembly to be the placement confirmation target, and displaying the entire image data on a display unit. Further, a fuel placement confirmation apparatus according to the present invention is a fuel placement confirmation apparatus used for refueling work of a boiling water reactor. The fuel placement confirmation apparatus includes an imaging device which images a fuel assembly number imprinted on a fuel assembly loaded into a core; a movement device which holds the imaging device and performs scanning in a horizontal plane above the fuel assembly; and a fuel placement confirmation processing unit which causes the movement device to perform scanning, repeatedly executes imaging by the imaging device on at least the fuel assembly to be a placement confirmation target, selects image data not including image distortion from a plurality of acquired imaged images, combines the image data, generates entire image data of at least the fuel assembly to be the placement confirmation target, and outputs the entire image data to a display unit.

### Advantageous Effects of Invention

According to the present invention, it is possible to provide a fuel placement confirmation method and a fuel placement confirmation apparatus that can increase an underwater imaging distance, collectively image a wide region, and reliably confirm an imprint number of a fuel assembly in consideration of a water fluctuation. Problems, configurations, and effects other than those described above will be further apparent from the following description of embodiments.

### BRIEF DESCRIPTION OF DRAWINGS

FIG. 1 is a diagram schematically showing an entire configuration of a fuel placement confirmation apparatus according to an embodiment of the present invention, together with fuel assemblies to be confirmation targets.

FIG. 2 is a functional block diagram of a fuel placement confirmation processing unit constituting the fuel placement confirmation apparatus shown in FIG. 1.

FIG. 3 is a processing flow diagram of the fuel placement confirmation processing unit shown in FIG. 2.

FIG. 4 is a schematic configuration diagram of an advanced boiling water reactor.

FIG. 5 is a diagram showing a top appearance of a core and a fuel storage pool.

FIG. 6 is a diagram showing a top appearance of the core.

FIG. 7 is a diagram showing an example of an imaged image including a recognition rate decrease region (visibility decrease region).

FIG. 8 is a diagram showing an example of determination results of a recognition rate decrease region (visibility decrease region) and a recognizable region (imprint character recognizable region).

FIG. 9 is a diagram showing an example of a plurality of recognizable regions and selected and combined image data.

FIG. 10 is a diagram showing an example in which merge processing is performed on a plurality of selected and combined image data to obtain entire image data.

### DESCRIPTION OF EMBODIMENTS

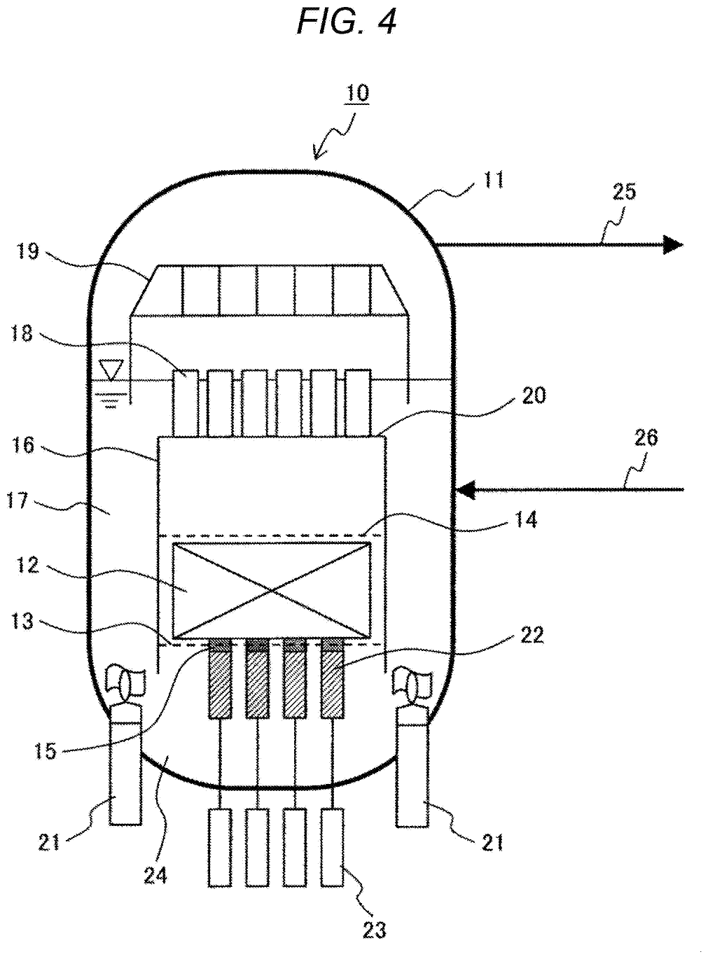

In the present specification, a boiling water reactor includes a normal boiling water reactor (BWR) that includes a recirculation pump and flows cooling water as a moderator to the outside of a reactor pressure vessel, flows the cooling water into a downcomer in the reactor pressure vessel again, and circulates the cooling water, an advanced boiling water reactor (ABWR) that includes an internal pump, an economic simplified boiling water reactor (ESBWR) that eliminates the need for the recirculation pump in BWR or the internal pump in ABWR by using a natural circulation system of the cooling water by a chimney, a resource-renewable boiling water reactor (RBWR), and the like. In the resource-renewable boiling water reactor (RBWR), a horizontal cross-sectional shape of a control rod is a Y shape. Hereinafter, the advanced boiling water reactor (ABWR) will be described as an example of a boiling water reactor to which a fuel placement confirmation method and a fuel placement confirmation apparatus according to the present invention are applied. FIG. 4 is a schematic configuration diagram of the advanced boiling water reactor. As shown in FIG. 4, in an advanced boiling water reactor 10, a cylindrical core shroud 16 is provided in a reactor pressure vessel 11, and a core 12 loaded with a plurality of fuel assemblies (not shown in the drawings) is installed in the core shroud 16. Further, a shroud head 20 covering the core 12, gas-water separators 18 attached to the shroud head 20 and extending upward, and a steam dryer 19 disposed above the gas-water separators 18 are provided in the reactor pressure vessel 11. An upper grid plate 14 is disposed in the core shroud 16 under the shroud head 20, is attached to the core shroud 16, and is located at an upper end of the core 12. A core support plate 13 is located at a lower end of the core 12, is disposed in the core shroud 16, and installed in the core shroud 16. Further, a plurality of fuel support metal fittings 15 are installed in the core support plate 13. Further, control rod guide pipes 22 that allow a plurality of control rods (not shown in the drawings) having a cross section in a horizontal cross-section to be inserted into the core 12 to control a nuclear reaction of the fuel assembly are provided in the reactor pressure vessel 11. Control rod drive mechanisms 23 are provided in a control rod drive mechanism housing (not shown in the drawings) installed under a bottom portion of the reactor pressure vessel 11, and the control rods are connected to the control rod drive mechanisms 23.

A plurality of internal pumps 21 are installed in a lower mirror 24 to be a bottom portion of the reactor pressure vessel 11 so as to penetrate into the reactor pressure vessel 11 from a portion under the reactor pressure vessel 11. The plurality of internal pumps 21 are disposed to be annularly separated from each other at a predetermined interval outside outermost circumferential portions of the plurality of control rod guide pipes 22. As a result, the internal pumps 21 do not interfere with the control rod guide pipes 22 or the like. In addition, an impeller of each internal pump 21 is located in an annular downcomer 17 formed between the cylindrical core shroud 16 and an inner surface of the reactor pressure vessel 11. The cooling water in the reactor pressure vessel 11 is supplied from the side of the lower mirror 24 to the core 12 through the downcomer 17, by the impeller of each internal pump 21. The cooling water flowing into the core 12 is heated by the nuclear reaction of the fuel assembly (not shown in the drawings) to form a gas-liquid two-phase flow, and flows into the gas-water separator 18. The gas-liquid two-phase flow flowing through the gas-water separator 18 is separated into steam (gas phase) containing moisture and water (liquid phase), and the liquid phase again falls to the downcomer 17 as the cooling water. On the other hand, the steam (gas phase) is introduced into the steam dryer 19 to remove the moisture, and is then supplied to a turbine (not shown in the drawings) through a main steam pipe 25. The cooling water flowing into the reactor pressure vessel 11 from a water supply pipe 26 via a condenser or the like flows through (falls down) the downcomer 17 in a downward direction. As such, the internal pump 21 forcibly circulates the cooling water to the core 12 to efficiently cool the heat generated in the core 12. Hereinafter, the case where a fuel placement confirmation method and a fuel placement confirmation apparatus according to an embodiment of the present invention are applied to the advanced boiling water reactor 10 will be described using the drawings.

### First Embodiment

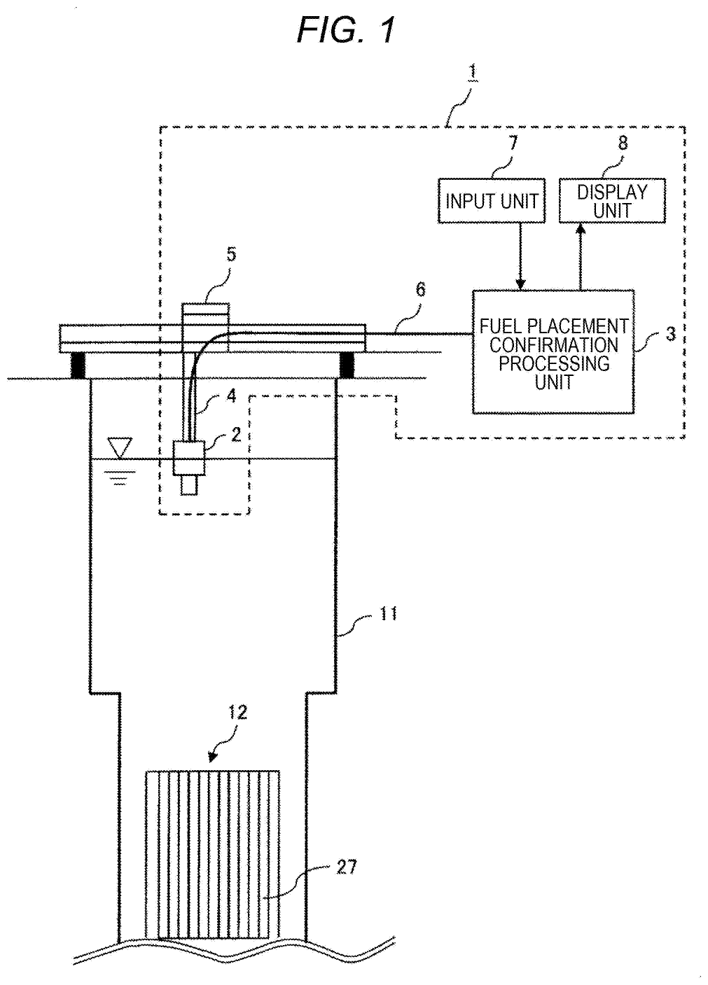

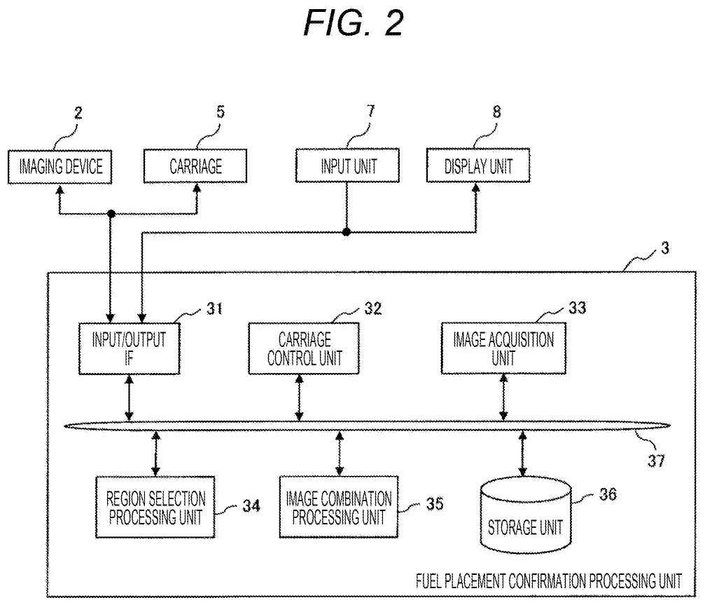

FIG. 1 is a diagram schematically showing an entire configuration of a fuel placement confirmation apparatus according to an embodiment of the present invention, together with fuel assemblies to be confirmation targets, and FIG. 2 is a functional block diagram of a fuel placement confirmation processing unit constituting the fuel placement confirmation apparatus shown in FIG. 1.

FIG. 1 shows a state in which a top cover (not shown in the drawings) of the advanced boiling water reactor 10 described above is removed and the gas-water separator 18 and the steam dryer 19 installed in the reactor pressure vessel 11 are removed. The fuel placement confirmation apparatus 1 includes an imaging device 2 that images top surfaces of fuel assemblies 27 to be imaging targets loaded into the core 12, a fixture 4 that fixes the imaging device 2 in a direction of the fuel assemblies 27, a carriage 5 that functions as a movement device mounted with the fixture 4 and scanning an operation floor height, a transmission cable 6 that transmits at least an image imaged by the imaging device 2 and a control signal to the carriage 5 functioning as the movement device, a fuel placement confirmation processing unit 3 that is connected to one end of the transmission cable 6, an input unit 7, and a display unit 8. The input unit 7 includes an input device such as a keyboard and/or a mouse, for example. An inspector (worker) uses the input unit 7 to previously input information of an imaging start position by the imaging device 2, scanning order by the carriage 5 functioning as the movement device, a size of an imaging visual field of the imaging device 2, maps (coordinate data) of all the fuel assemblies 27 loaded into the core 12, various thresholds, and the like, for example. Further, the display unit 8 has a display device such as a liquid crystal display (LCD) or an organic EL display, for example, and displays image data of a confirmation result of the placement of the fuel assemblies 27 to be the imaging targets loaded into the core 12, which is described in detail later. In an example shown in FIG. 1, the case where an imaging unit of the imaging device 2 is located in the water near a water surface is shown. However, the present invention is not limited thereto, and the imaging unit of the imaging device 2 may be configured to be located above the water surface, that is, in the air. As compared with when the imaging unit of the imaging device 2 is located in the water near the water surface, when the imaging unit of the imaging device 2 is located in the air, this is desirable in that an underwater imaging distance, that is, a distance from the imaging unit of the imaging device 2 to the top surface of the fuel assembly 27 to be the imaging target increases and a wide region is collectively imaged. In other words, when the imaging unit of the imaging device 2 is located in the air, it is possible to widen the imaging visual field, as compared with when the imaging unit of the imaging device 2 is located in the water near the water surface.

Further, in the example shown in FIG. 1, the case where the carriage 5 is used as the movement device mounted with the fixture 4 to fix the imaging device 2 in the direction of the fuel assembly 27 and scanning the operation floor height is shown. However, the present invention is not limited thereto. For example, a refueling machine may be used instead of the carriage 5 functioning as the movement device. When the refueling machine is used as the movement device, the placement of the fuel assemblies 27 can be confirmed sequentially at the time of the replacement work of the fuel assemblies 27 in the core 12. The case where the carriage 5 is used as an example of the movement device will be described below. In the case where the carriage 5 is used as the movement device, after completing the replacement work of the fuel assemblies 27 loaded into the core 12 by the refueling machine, for example, in four batches, the carriage 5 is installed and confirmation work of the placement of the fuel assemblies 27 is performed.

As shown in FIG. 2, the fuel placement confirmation processing unit 3 includes an input/output I/F 31, a carriage control unit 32, an image acquisition unit 33, a region selection processing unit 34, an image combination processing unit 35, and a storage unit 36, and these are mutually connected via an internal bus 37 so as to be accessible. The carriage control unit 32, the image acquisition unit 33, the region selection processing unit 34, and the image combination processing unit 35 constituting the fuel placement confirmation processing unit 3 are realized by a processors such as a central processing unit (CPU) not shown in the drawings, a ROM storing various programs, a RAM temporarily storing data of an operation process, and a storage device such as an external storage device, for example, and the processor such as the CPU reads and executes the various programs stored in the ROM and stores an operation result to be an execution result in the RAM or the external storage device.

The carriage control unit 32 accesses the storage unit 36 via the internal bus 37, reads the information of the imaging start position by the imaging device 2, the size of the imaging visual field of the imaging device 2, and/or the scanning order by the carriage 5 functioning as the movement device, stored previously in the storage unit 36, and outputs a control signal to the carriage 5 functioning as the movement device via the input/output I/F 31. As a result, the carriage 5 that functions as the movement device mounted with the fixture 4 for fixing the imaging device 2 in the direction of the fuel assembly 27 moves to the imaging start position and scans the operation floor height. The image acquisition unit 33 outputs an imaging instruction to the imaging device 2 via the input/output I/F 31, and acquires imaged image data of the top surface of the fuel assembly 27 to be the imaging target loaded into the core 12, imaged by the imaging unit of the imaging device 2, via the input/output I/F 31 and the internal bus 37. In addition, an image imaged by the imaging unit of the imaging device 2 is a still image or a moving image. In the case of the still image, the still image is imaged at a point of time when the imaging device 2 is positioned stepwise according to the size of the imaging visual field, by the carriage 5 functioning as the movement device. In the case of the moving image, still image data of the moving image imaged by the imaging device 2 while the imaging device 2 moves stepwise by the carriage 5 functioning as the movement device is associated with a position (determined from a relation with a position of the carriage 5) of the imaging device 2, is taken in the image acquisition unit 33, and is stored in the storage unit 36 via the internal bus 37.

The region selection processing unit 34 selects an image region used for image combination processing from the imaged image data of the top surface of the fuel assembly 27 transferred from the image acquisition unit 33 via the internal bus 37. The details of the selection of the image region used for the image combination processing will be described later. The image combination processing unit 35 combines a plurality of selected image regions transferred from the region selection processing unit 34 via the internal bus 37. In addition, the image combination processing unit 35 stores combined entire image data in the storage unit 36 via the internal bus 37, and outputs the combined entire image data to the display unit 8 via the internal bus 37 and the input/output I/F 31. Further, the storage unit 36 stores the information of the imaging start position by the imaging device 2, the scanning order by the carriage 5 functioning as the movement device, the size of the imaging visual field of the imaging device 2, the maps (coordinate data) of all the fuel assemblies 27 loaded into the core 12, the various thresholds, and the like, previously input via the input unit 7, as described above.

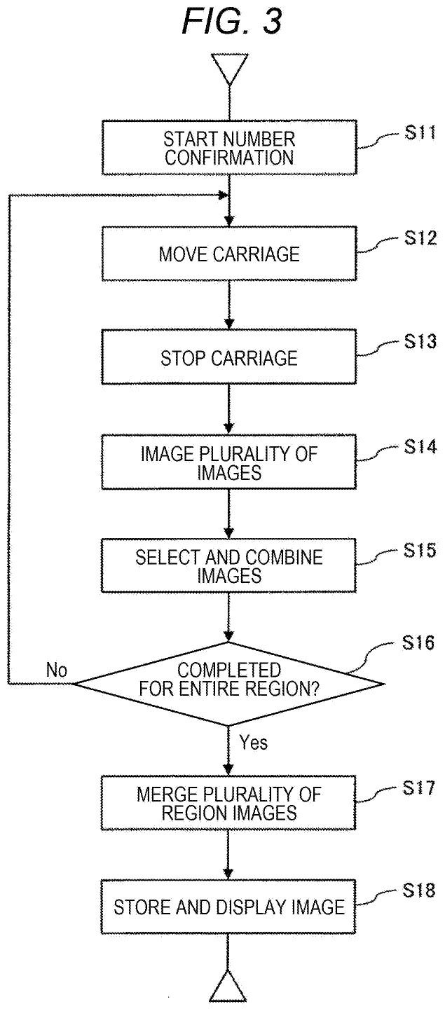

Next, a flow of processing by the fuel placement confirmation processing unit 3 will be described. FIG. 3 shows a processing flow diagram of the fuel placement confirmation processing unit 3. When a number confirmation step starts in start step S11, in carriage movement step S12, the carriage control unit 32 accesses the storage unit 36 via the internal bus 37, reads the information of the imaging start position and the maps (coordinate data) of all the fuel assemblies 27 loaded into the core 12, stored in the storage unit 36, and outputs the control signal to the carriage 5 functioning as the movement device via the input/output I/F 31. The carriage 5 functioning as the movement device moves until the imaging device 2 moves to a position (imaging start position) at which the imaging device 2 images an imprint number of the fuel assembly 27, on the basis of the control signal. In carriage stop step S13, the carriage 5 functioning as the movement device stops when it reaches the imaging start position. In plural image imaging step S14, the imaging device 2 images the top surface of the fuel assembly 27 to be the imaging target a plurality of times, on the basis of the imaging instruction output from the image acquisition unit 33 via the input/output I/F 31. That is, the imaging device 2 executes imaging a plurality of times at the same imaging position (here, the imaging start position). A plurality of imaged images are input to the image acquisition unit 33 via the transmission cable 6, the input/output I/F 31, and the internal bus 37.

In image selection and combination step S15, the region selection processing unit 34 executes region selection and combination processing for identifying regions (recognizable regions) visible by the inspector (worker) and a recognition rate decrease region to be described in detail later, on the basis of a plurality of imaged image data obtained by performing imaging a plurality of times at the same imaging position (here, the imaging start position), transferred from the image acquisition unit 33, selecting and combining the recognizable regions among the plurality of imaged image data, and generating selected and combined image data.

In entire region completion determination step S16, the region selection processing unit 34 determines whether or not an entire region of the fuel assembly to be a number confirmation target has been imaged. Here, in the determination on whether or not the entire region of the fuel assembly to be the number confirmation target has been imaged, the region selection processing unit 34 accesses the storage unit 936 via the internal bus 37, refers to the size of the imaging visual field of the imaging device 2, the imaging position by the imaging device 2, and the maps (coordinate data and the like) of all the fuel assemblies loaded into the core 12, previously stored in the storage unit 36, and determines whether or not the entire region has been completed, from a relation between “the entire region of the fuel assembly to be the number confirmation target” and “the imaging visual field and the imaging position of the imaging device 2 to be scanned”. When a determination result in entire region completion determination step S16 is “No”, the process returns to carriage movement step S12 described above, and the carriage control unit 32 accesses the storage unit 36 via the internal bus 37 and performs control so that the carriage 5 moves to a next imaging position, on the basis of the scanning order stored in the storage unit 36. Then, the processing up to carriage stop step S13, plural image imaging step S14, image selection and combination step S15, and entire region completion determination step S16 is repeatedly executed.

On the other hand, as the determination result in entire region completion determination step S16, when the entire region has been completed, the process proceeds to plural region image merge step S17.

In plural region image merge step S17, the image combination processing unit 35 acquires the plurality of selected and combined image data generated by the region selection processing unit 34 in image selection and combination step S15 described above, merges them according to the imaging position, and generates entire image data. In image storage/image display step S18, the image combination processing unit 35 stores the entire image data generated in plural region image merge step S17 in a predetermined storage area of the storage unit 36 via the internal bus 37, and outputs the generated entire image data to the display unit 8 via the internal bus 37 and the input/output I/F 31. As a result, the entire image data is displayed on a screen of the display unit 8.

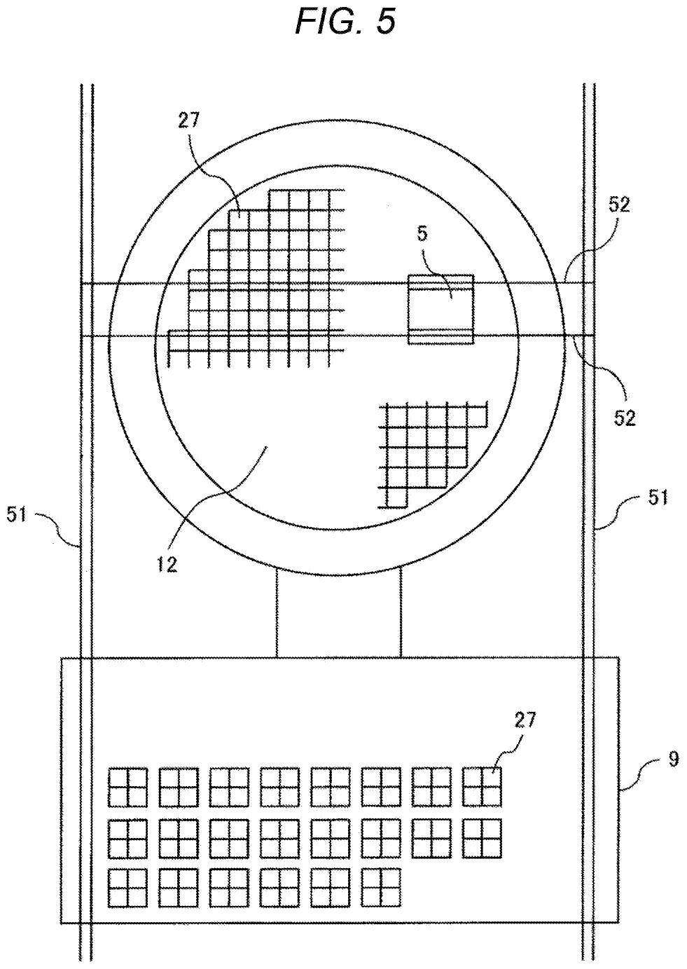

The details of each step described above will be individually described below. First, the details of the movement of the carriage 5 functioning as the movement device on which the imaging device 2 is mounted will be described using FIG. 5. FIG. 5 is a diagram showing a top appearance of the core 12 and a fuel storage pool 9. The carriage 5 functioning as the movement device has a structure in which a plane on the core 12 and the fuel storage pool 9 can be moved to an arbitrary position by a combination of parallel movements of two orthogonal axes. Specifically, as shown in FIG. 5, rails 51 that are arranged in parallel with each other, are separated from each other at a predetermined interval, and extend across a region where the core 12 and fuel storage pool 9 are installed are provided above the core 12 and fuel storage pool 9. Further, rails 52 that is perpendicular to the rails 51 provided in parallel with each other, are separated from each other at a predetermined interval, and enables travelling of the carriage 5 functioning as the movement device are provided. If the carriage 5 functioning as the movement device is placed on the two rails 52, first, the two rails 52 slide on the two rails 51 to a desired position above the core 12 and the fuel storage pool 9. After that, the carriage 5 functioning as the movement device travels on the two rails 52, so that the carriage 5 mounted with the fixture 4 for fixing the imaging device 2 in the direction of the fuel assembly 27 is located at a desired position. As shown in FIG. 5, in the fuel storage pool 9, spent fuel assemblies and new fuel assemblies are stored in a cell unit including the four fuel assemblies 27 adjacent to each other. In carriage movement step S12 in FIG. 3 described above, the carriage 5 functioning as the movement device moves to a previously designated position where the imaging device 2 is disposed above the fuel assembly 27 to be imaged, according to the control signal from the carriage control unit 32 constituting the fuel placement confirmation processing unit 3, and in carriage stop step S13, the carriage 5 functioning as the movement device stops at the designated position, according to the control signal from the carriage control unit 32 constituting the fuel placement confirmation processing unit 3.

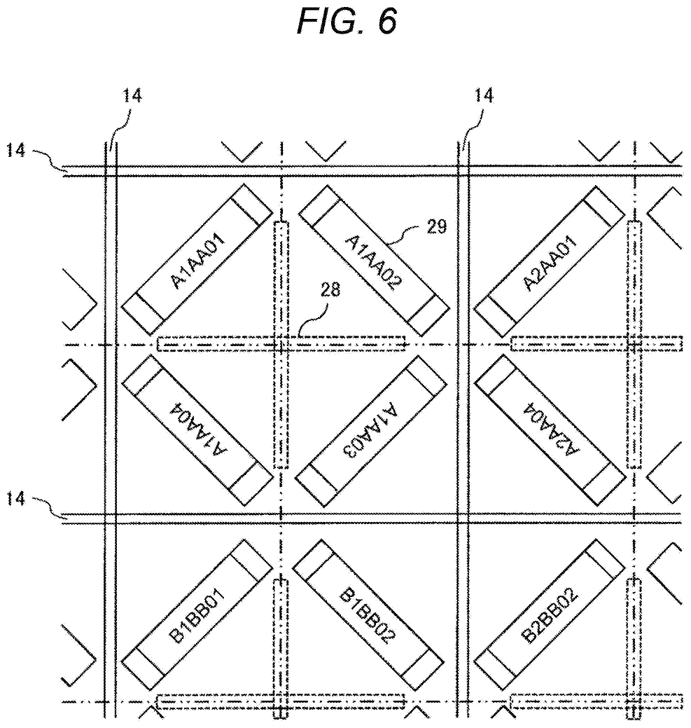

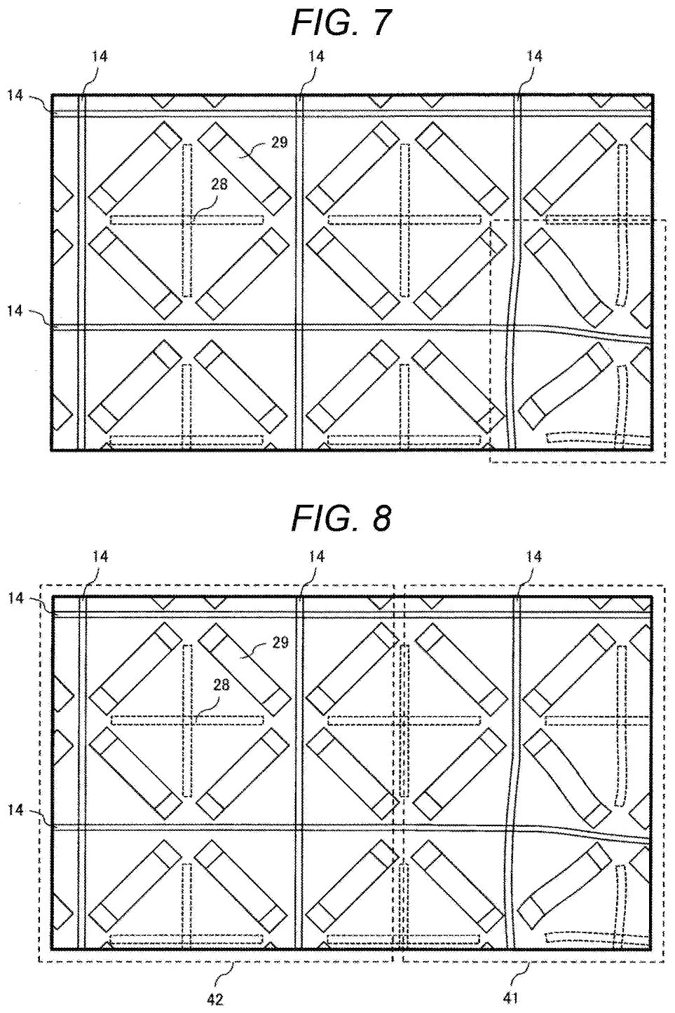

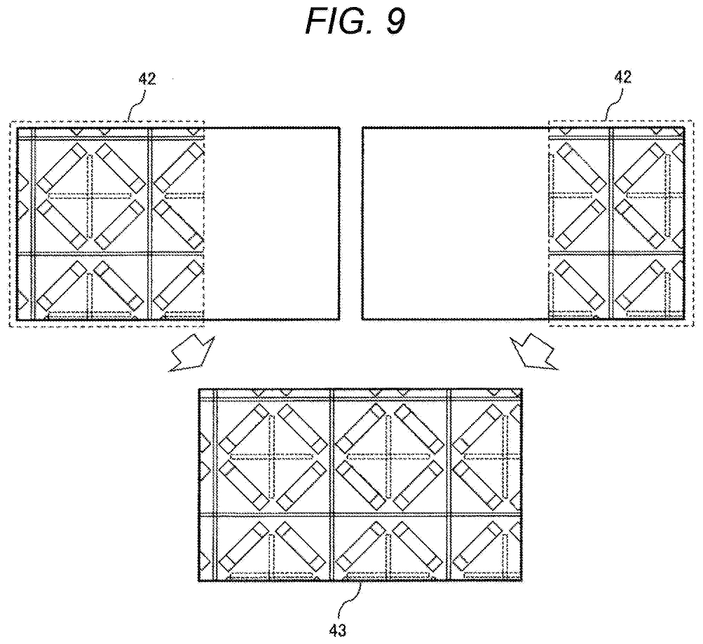

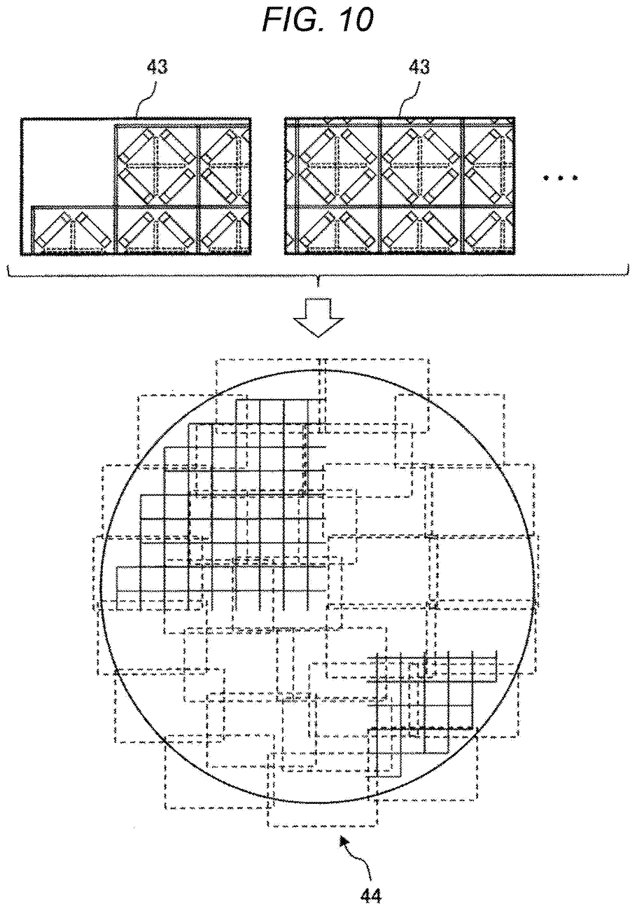

Next, the details of imaging by the imaging device 2 in plural image imaging step S14 will be described using FIG. 6. FIG. 6 is a diagram showing a top appearance of the core, which shows a part of a top appearance of the fuel assembly 27 loaded into the core 12. A control rod 28 having a cross section in a horizontal cross-section is disposed at a center position of the upper grid plate 14 sectioned in a square, and the fuel assemblies 27 are loaded one by one on all four sides of the control rod 28 so as to surround the control rod 28. Handles 29 are attached to the tops of the fuel assemblies 27, and the fuel assemblies 27 are loaded so that the handles 29 of the four fuel assemblies 27 surround the center of the control rod 28, at an angle of 45 degrees to a blade direction of the control rod 28. The four fuel assemblies 27 and the control rod 28 constitute one cell. A fuel assembly number is imprinted on the handle 29 of the fuel assembly 27 along a direction of the handle. That is, when the core 12 is viewed from the top, imprint numbers of all the fuel assemblies 27 loaded into the core 12 can be observed. In an example shown in FIG. 6, as imprint numbers of the four fuel assemblies 27 that form a cell loaded into a upper left portion, an imprint number of the fuel assembly 27 loaded into an upper left portion in the cell is “A1AA01”, an imprint number of the fuel assembly 27 loaded into an upper right portion is “A1AA02”, an imprint number of the fuel assembly 27 loaded into a lower right portion is “A1AA03”, and an imprint number of the fuel assembly 27 loaded into a lower left portion is “A1AA04”. In plural image imaging step S14, imaging of the same region as FIG. 6 is performed using the imaging device 2, by the imaging instruction from the image acquisition unit 33. That is, FIG. 6 corresponds to the imaging visual field by the imaging unit of the imaging device 2. At this time, imaging at the same position is performed a plurality of times. That is, a plurality of images obtained by imaging the same region are acquired. The plurality of imaged image data acquired by the image acquisition unit 33 are transferred to the region selection processing unit 34 via the internal bus 37, and image selection and combination step S15 is executed by the region selection processing unit 34. Next, the details of the image processing executed by the region selection processing unit 34 in image selection and combination step S15 will be described using FIGS. 7 to 9. FIG. 7 is a diagram showing an example of an imaged image including a recognition rate decrease region (visibility decrease region), FIG. 8 is a diagram showing an example of determination results of the recognition rate decrease region (visibility decrease region) and a recognizable region (imprint character recognizable region), and FIG. 9 is a diagram showing an example of a plurality of recognizable regions and selected and combined image data.

In the region selection processing unit 34, a region (recognizable region) where imprint characters are recognizable and a region (recognition rate decrease region) where it is difficult to recognize the imprint characters due to an influence of visibility decrease factors such as an underwater fluctuation and external light are determined (identified) from the imaged image data, on the basis of a certain index. Here, first, the case where a linear component in the imaged image data is extracted and determination based on an influence degree of the underwater fluctuation is performed will be described. FIG. 7 shows an example of imaged image data including a region having an influence of the underwater fluctuation. When imaging is performed in an underwater fluctuation environment, random refraction of light occurs due to a density difference in water and light does not go straight, so that distortion occurs in the imaged image data. In the imaged image data shown in FIG. 7, the distortion occurs in a region of a lower right portion, and a structure formed by straight lines of the upper grid plate 14, the control rod 28, and the handle 29 of the fuel assembly 27 is imaged in a curved shape. A distortion occurrence region is specified by extracting a curved portion in the imaged image data, and a region (recognizable region) in which the underwater fluctuation does not occur and the imprint characters are recognizable is selected. In the image processing, first, the region of the upper grid plate 14 is extracted and thinned using brightness binarization processing. A line segment obtained by thinning is divided into a straight portion and a curved portion by a curvature. Next, as shown in FIG. 8, a region including the curved portion is determined as a recognition rate decrease region 41 where the underwater fluctuation occurs and a region including only the straight portion is determined as a recognizable region 42 where the underwater fluctuation does not occur and the imprint characters are recognizable. As a result, in the imaged image data, the recognition rate decrease region 41 and the recognizable region 42 are identified, and selection of the recognizable region 42 to be a region where the imprint characters are recognizable is performed.

A method described here is an example, and other processing method in which the same effect is obtained may be used. For example, the region used for straight line and curved line determination is not limited to the upper grid plate 14, and a region having a straight line structure such as the control rod 28 and the handle 29 of the fuel assembly 27 may be used. Further, in the region extraction, in addition to the brightness binarization processing, other processing such as processing for extracting a brightness change point like edge extraction processing or the like, in which the same effect is obtained, may be used. Furthermore, for the index for determining the region (recognizable region 42) where the imprint characters are recognizable, in addition to the processing for extracting the curved line of the imaged image data, processing using other index changing due to the underwater fluctuation, such as a brightness contrast, may be used.

When the brightness contrast is used, brightness values of the upper grid plate 14, the control rod 28, the handle 29 of the fuel assembly 27, and the like are acquired, and a high brightness region and a low brightness region are set. In each of the acquired image data, for a specific range, a brightness value of the high brightness region is H, a brightness value of the low brightness region is L, and contrast C is calculated as C=(H−L)/(H+L). A range in which the contrast C is larger than a preset value is determined as a region in which the imprint characters are recognizable and a range in which the contrast C is smaller than the preset threshold is determined as a region (recognition rate decrease region 41) in which the recognition rate decreases. The threshold used for the determination may be freely set according to conditions according to the purpose or is previously input by the inspector (worker) via the input unit 7 and is stored in a predetermined storage area of the storage unit 36 via the input/output I/F 31 and the internal bus 37.

In addition to the above, the region determination may be performed using another factor that changes due to the underwater fluctuation. Furthermore, another processing may be applied to the underwater fluctuation and another recognition rate decrease factor. For example, in the case of determining a recognition rate decrease region (recognition rate decrease region 41) due to external light, a brightness value sum or a brightness average value for each region is calculated, and a region having a value larger than a preset threshold is determined as the recognition rate decrease region 41 and a region having a value smaller than the preset threshold is determined as the imprint character recognizable region (recognizable region 42). The threshold used for the determination may be freely set according to the conditions according to the purpose, and which one of the regions having the values larger and smaller than the threshold is set to the imprint character recognizable region (recognizable region 42) may be freely set. The imprint character recognizable region (recognizable region 42) according to the method described above is extracted from a plurality of imaged image data transferred from the image acquisition unit 33 via the internal bus 37.

Furthermore, as another method, for example, imaged image data of a regular cell unit may be stored in advance as a template in the storage unit 36, and the imaged image data after edge extraction or edge enhancement processing on the image acquired by the imaging device 2 may be configured to perform template matching processing using the template stored in the storage unit 36. In this case, matching is determined when differential image data between the template and the imaged image data on which the above processing has been executed is within a predetermined threshold. That is, it is determined that the region is the recognizable region 42 to be a visible region. For the template, image data obtained by dividing imaged image data of the normal cell into two parts or four parts, or imaged image data of two cells adjacent to each other according to the imaging visual field of the imaging device 2 may be used as the template.

As shown in FIG. 9, by combining the recognizable regions 42 of the imprint characters obtained from the respective imaged image data, selected and combined image data 43 excluding the recognition rate decrease region 41 can be obtained with respect to the region imaged at the same position of the imaging device. The selected and combined image data 43 capable of recognizing the imprint characters is generated by the method described above, and the execution of image selection and combination step S15 by the region selection processing unit 34 is completed. In the method described above, the case where plural image imaging step S14 and image selection and combination step S15 are sequentially executed has been described. However, the method of obtaining the recognizable image is not limited thereto. For example, a method of repeatedly executing plural image imaging step S14 and image selection and combination step S15 may be used. In this case, first, in plural image imaging step S14, the image acquisition unit 33 outputs an imaging instruction to the imaging device 2 via the input/output I/F 31, and one or more images are imaged by the imaging unit of the imaging device 2. Then, in image selection and combination step S15, the region selection processing unit 34 acquires the imaged image data capable of recognizing the imprint characters from the imaged image data transferred from the image acquisition unit 33 via the internal bus 37. At this time, when the image region (recognizable region 42) capable of recognizing the imprint characters is not the entire range of the imaged image data transferred from the image acquisition unit 33, that is, the recognition rate decrease region 41 remains in the range of the imaged image data transferred from the image acquisition unit 33, a flow in which the process returns to plural image imaging step S14, one or more images are imaged again by the imaging unit of the imaging device 2, and the region selection processing unit 34 executes image selection and combination step S15 is repeated until the entire range of the imaged image data transferred from the image acquisition unit 33 becomes the region where the imprint characters are recognizable. By the above method, the selected and combined image data 43 capable of recognizing the imprint characters is generated, and the processing up to image selection and combination step S15 is completed. Next, in entire region completion determination step S16, when the entire imaging region of the fuel assembly 27 to be the imaging target is included in the selected and combined image data 43 capable of recognizing the imprint characters obtained in image selection and combination step S15, the region selection processing unit 34 completes plural image imaging step S14 and image selection and combination step S15, and proceeds to plural region image merge step S17 in which the plurality of imprint character recognizable images are merged as an entire image. When the selected and combined image data 43 capable of recognizing the imprint characters does not include the entire imaging region of the fuel assembly 27 to be the imaging target, in order to move to a region not to be imaged and perform imaging, the process proceeds to carriage movement step S12, the movement of the carriage 5 functioning as the movement device, plural image imaging step S14 by the imaging unit of the imaging device 2, and image selection and combination step S15 are repeatedly executed.

Next, the details of the image processing executed by the image combination processing unit 35 in plural region image merge step S17 will be described using FIG. 10. FIG. 10 is a diagram showing an example in which merge processing is performed on the plurality of selected and combined image data to obtain the entire image data 43. The image combination processing unit 35 maps the selected and combined image data 43 generated by the region selection processing unit 34, on the basis of the imaged image data transferred from the image acquisition unit 33 via the internal bus 37, according to the position of the imaging device 2 at the time of imaging an image, and generates the entire image data 44 in which the entire core 12 and the imprint numbers of all the fuel assemblies 27 have been imaged. In the example shown in FIG. 10, the image combination processing unit 35 acquires the plurality of selected and combined image data 43 from the region selection processing unit 34 via the internal bus 37, together with imaging position information. Further, the image combination processing unit 35 accesses the storage unit 36 via the internal bus 37, refers to the maps (coordinate data or the like) of all the fuel assemblies 27 loaded into the core 12, stored in advance in the storage unit 36, combines the plurality of selected and combined image data 43 on the basis of the maps, and generates the entire image data 44, as shown in the lower diagram of FIG. 10. The image combination processing unit 35 outputs the generated entire image data 44 to the display unit 8 through the internal bus 37 and the input/output I/F 31, and the entire image data 44 is displayed as a confirmation image on the screen of the display unit 8, in a state where it is visually recognizable by the inspector (worker). Further, the image combination processing unit 35 stores the generated entire image data 44 as a confirmation recording material in a predetermined storage area of the storage unit 36 via the internal bus 37. As a result, for the total number of fuel assemblies 27 loaded into the core 12, the imprint numbers thereof can be confirmed at high speed. In the present embodiment, the example in which the entire image data 44 in which the imprint numbers have been imaged is stored in the storage unit 36 and is displayed on the screen of the display unit 8 has been described. However, the present invention is not necessarily limited thereto. For example, the imprint character region in the selected and combined image data 43 or the entire image data 44 may be extracted by the image processing, and the extracted characters may be recognized by character recognition processing and/or determination processing may be included. Further, in the present embodiment, the example in which the selected and combined image data 43 generated by the region selection processing unit 34 is mapped and the entire image data 44 in which the entire core 12 and the imprint numbers of all the fuel assemblies 27 have been imaged has been described. However, the present invention is not necessarily limited thereto. For example, when refueling is performed in four batches, the image data in which the imprint number of the refueled fuel assembly 27 has been imaged may be used as the entire image data 44.

As described above, according to the present embodiment, it is possible to provide a fuel placement confirmation method and a fuel placement confirmation apparatus that can increase an underwater imaging distance, collectively image a wide region, and reliably confirm an imprint number of a fuel assembly in consideration of a water fluctuation. Further, according to the present embodiment, entire image data is obtained by generating selected and combined image data capable of recognizing imprint characters from a plurality of imaged image data and combining the plurality of generated selected and combined image data. Therefore, imprint numbers of the fuel assemblies loaded into the core can be confirmed at high speed. Further, according to the present embodiment, the refueling machine is used as the movement device, so that it is possible to perform sequential placement confirmation at the time of refueling work.

The present invention is not limited to the embodiments described above and various modifications are included. For example, the embodiments are described in detail to facilitate the understanding of the present invention and the present invention is not limited to including all of the described configurations.

### REFERENCE SIGNS LIST

1 fuel placement confirmation apparatus
2 imaging device
3 fuel placement confirmation processing unit
4 fixture
5 carriage
6 transmission cable
7 input unit
8 display unit
9 fuel storage pool
10 advanced boiling water reactor
11 reactor pressure vessel
12 core
13 core support plate
14 upper grid plate
15 fuel support metal fitting
16 core shroud
17 downcomer
18 gas-water separator
19 vapor dryer
20 shroud head
21 internal pump
22 control rod guide pipe
23 control rod drive mechanism
24 lower mirror
25 main vapor pipe
26 water supply pipe
27 fuel assembly
28 control rod
29 handle
31 input/output I/F
32 carriage control unit
33 image acquisition unit
34 region selection processing unit
35 image combination processing unit
36 storage unit
37 internal bus
41 recognition rate decrease region
42 recognizable region
43 selected and combined image data
44 entire image data
51, 52 rail

1. A fuel placement confirmation method for refueling work of a boiling water reactor, comprising:
imaging a fuel assembly number imprinted on a fuel assembly by an imaging device attached to a movement device;
causing the movement device to perform scanning and repeatedly executing imaging by the imaging device on at least the fuel assembly to be a placement confirmation target; and
selecting image data not including image distortion from a plurality of acquired imaged images, combining the image data, generating entire image data of at least the fuel assembly to be the placement confirmation target, and displaying the entire image data on a display unit.

2. The fuel placement confirmation method according to claim 1, wherein the imaging device attached to the movement device images the fuel assembly number imprinted on the fuel assembly in a state of being placed in the air.

3. The fuel placement confirmation method according to claim 1, wherein processing of selecting the image data not including the image distortion from the plurality of acquired imaged images and combining the image data determines a visibility decrease region from the plurality of imaged images, combines regions other than the visibility decrease region, and obtains image data in which the fuel assembly number is visually recognizable.

4. The fuel placement confirmation method according to claim 3, wherein the processing of selecting the image data not including the image distortion from the plurality of acquired imaged images and combining the image data uses curvatures of line segments in the imaged images for the determination of the visibility decrease region.

5. The fuel placement confirmation method according to claim 3, wherein the processing of selecting the image data not including the image distortion from the plurality of acquired imaged images and combining the image data determines a region where a brightness contrast of the imaged images is smaller than a predetermined threshold as the visibility decrease region.

6. The fuel placement confirmation method according to claim 3, wherein the processing of selecting the image data not including the image distortion from the plurality of acquired imaged images and combining the image data determines a region where a brightness average value of the imaged images is smaller than a predetermined threshold as the visibility decrease region.

7. The fuel placement confirmation method according to claim 4, wherein the processing of selecting the image data not including the image distortion from the plurality of acquired imaged images and combining the image data determines the visibility decrease region from the plurality of imaged images, and repeatedly executes the imaging by the imaging device until the visibility decrease region is not included, when the visibility decrease region is included.

8. A fuel placement confirmation apparatus used for refueling work of a boiling water reactor, comprising:
an imaging device which images a fuel assembly number imprinted on a fuel assembly loaded into a core;
a movement device which holds the imaging device and performs scanning in a horizontal plane above the fuel assembly; and
a fuel placement confirmation processing unit which causes the movement device to perform scanning, repeatedly executes imaging by the imaging device on at least the fuel assembly to be a placement confirmation target, selects image data not including image distortion from a plurality of acquired imaged images, combines the image data, generates entire image data of at least the fuel assembly to be the placement confirmation target, and outputs the entire image data to a display unit.

9. The fuel placement confirmation apparatus according to claim 8, wherein the imaging device images the fuel assembly number imprinted on the fuel assembly in a state of being placed in the air.

10. The fuel placement confirmation apparatus according to claim 8, wherein the fuel placement confirmation processing unit includes a region selection processing unit which determines a visibility decrease region from the plurality of imaged images, combines regions other than the visibility decrease region, and generates image data in which the fuel assembly number is visually recognizable.

11. The fuel placement confirmation apparatus according to claim 10, wherein the region selection processing unit determines the visibility decrease region from the plurality of imaged images, on the basis of curvatures of line segments in the imaged images.

12. The fuel placement confirmation apparatus according to claim 10, wherein the region selection processing unit determines a region where a brightness contrast of the imaged images is smaller than a predetermined threshold as the visibility decrease region.

13. The fuel placement confirmation apparatus according to claim 10, wherein the region selection processing unit determines a region where a brightness average value of the imaged images is smaller than a predetermined threshold as the visibility decrease region.

14. The fuel placement confirmation apparatus according to claim 11, wherein the fuel placement confirmation processing unit includes an image acquisition unit which outputs an imaging instruction to the imaging device and acquires the plurality of imaged images from the imaging device,
the region selection processing unit determines the visibility decrease region from the plurality of imaged images from the image acquisition unit, and
the image acquisition unit repeatedly outputs the imaging instruction to the imaging device until the visibility decrease region determined by the region selection processing unit is not included, so as to repeat the imaging by the imaging device.

15. The fuel placement confirmation apparatus according to claim 14, wherein the movement device is a refueling machine and is mounted with a fixture for fixing the imaging device in a direction of the fuel assembly.

16. The fuel placement confirmation method according to claim 2, wherein processing of selecting the image data not including the image distortion from the plurality of acquired imaged images and combining the image data determines a visibility decrease region from the plurality of imaged images, combines regions other than the visibility decrease region, and obtains image data in which the fuel assembly number is visually recognizable.

17. The fuel placement confirmation apparatus according to claim 9, wherein the fuel placement confirmation processing unit includes a region selection processing unit which determines a visibility decrease region from the plurality of imaged images, combines regions other than the visibility decrease region, and generates image data in which the fuel assembly number is visually recognizable.
